(19) United States
(12) Patent Application Publication
(10) Pub. No.: US 2015/0050441 A1
(43) Pub. Date: Feb. 19, 2015

(54) STRUCTURAL COMPONENT SEMI-FINISHED PART FOR PRODUCING A FIBER-REINFORCED STRUCTURAL COMPONENT AS WELL AS STRUCTURAL COMPONENT AND METHOD FOR THE PRODUCTION THEREOF

(71) Applicant: superTEX composites GmbH, Telfs (AT)

(72) Inventor: Valentine Troi, Innsbruck (AT)

(21) Appl. No.: 14/386,548

(22) PCT Filed: Mar. 22, 2013
(86) PCT No.: PCT/EP2013/056012

§ 371 Date: Sep. 19, 2014

(30) Foreign Application Priority Data
Mar. 22, 2012 (DE) 10 2012 204 604.6

(51) Int. Cl. B32B 1/08; B29C 45/16; B29C 45/00

(52) U.S. Cl. CPC B32B 1/08; B29C 45/0005; B29C 45/1642; B32B 2250/03; B32B 2305/08; B32B 2597/00; B29L 2023/22
USPC 428/36.4; 264/257

(57) ABSTRACT

A structural component semi-finished part has two wall elements which at least partly define a receiving space in a transverse direction. The receiving space extends in a longitudinal direction. In the receiving space, reinforcing fibers are arranged. In order to distribute a matrix material in the receiving space, a flow aid is provided which is configured as at least one channel at a side of at least one of the wall elements facing the receiving space. The at least one channel allows the matrix material to be easily and rapidly distributed throughout the receiving space in order to provide the reinforcing fibers with matrix material. In order to produce a structural component having an at least partly curved desired shape, the wall elements are formable. In order to produce a fiber-reinforced structural component, the structural component semi-finished part is deformed into a desired shape, and flowable matrix material is introduced into the receiving space via an inlet opening, wherein the matrix material spreads via the at least one channel so as to impregnate the reinforcing fibers. Subsequently, the matrix material cures to form the structural component.

### CROSS REFERENCE TO RELATED APPLICATIONS

This application is a United States National Phase application of International Application PCT/EP2013/056012 filed Mar. 22, 2013 and claims the benefit of priority under 35 U.S.C. §119 of German Patent Application DE 10 2012 204 604.6 filed Mar. 22, 2012, the entire contents of which are incorporated herein by reference.

### FIELD OF THE INVENTION

The invention relates to a structural component semi-finished part for producing a fiber-reinforced structural component, comprising a first wall element, a second wall element surrounding the first wall element, a receiving space which is bounded by the wall elements at least in a transverse direction, which extends between the wall elements in a longitudinal direction, and which has a circumferential cross-section, reinforcing fibers arranged in the receiving space, an inlet opening in order to introduce flowable matrix material into the receiving space, and a flow aid in order to distribute the matrix material in the receiving space, wherein the flow aid is configured as at least one channel at a side of at least one wall element facing the receiving space. The invention further relates to a fiber-reinforced structural component and to a method for the production thereof.

### BACKGROUND OF THE INVENTION

A fiber-reinforced structural component is known from WO 2010/129 975 A2 which is easily producible and suitable for use in the most various applications. The structural component has a tubular inner wall to which at least one layer of reinforcing fibers is applied. The reinforcing fibers are in turn surrounded by a cylindrical outer wall element. As a result, a semi-finished part is obtained which is easily and flexibly formable, thus allowing desired shapes to be produced according to requirements. In order to produce the structural component, a liquid or flowable plastic material, which is also referred to as matrix or matrix material, is introduced into the receiving space defined between the wall elements. As soon as the plastic material has cured, it forms a fiber composite material together with the reinforcing fibers which has a high stability. The finished structural component has the desired shape which was easily produced prior to curing of the plastic material.

In order to easily introduce or infuse the liquid plastic material between the inner wall element and the outer wall element, a flow aid is arranged between the wall elements. The flow aid is for instance configured as a meshwork or a woven structure of plastic fibers along which the liquid plastic material spreads throughout the receiving space so as to impregnate the reinforcing fibers.

A fiber-reinforced tubular body is known from EP 1 170 117 A1 which is configured linearly. The fiber-reinforced tubular body has a tubular core, a fiber-reinforced layer and a resin distribution medium arranged therebetween which are surrounded by an airtight material such as for instance a vacuum hose. The resin distribution medium is configured in the form of grooves which extend in the longitudinal direction and in a direction perpendicular thereto. When producing curved fiber-reinforced tubular bodies, the airtight material is formed by a female mold into which the tubular core comprising the fiber-reinforced layer must be inserted.

### SUMMARY OF THE INVENTION

An object of the invention is to provide a structural component semi-finished part which provides an easier and improved manner of producing a fiber-reinforced structural component having a desired shape.

This object is achieved by a structural component semi-finished part for producing a fiber-reinforced structural component, comprising a first wall element, a second wall element surrounding the first wall element, a receiving space which is bounded by the wall elements at least in a transverse direction, which extends between the wall elements in a longitudinal direction, and which has a circumferential cross-section, reinforcing fibers arranged in the receiving space, an inlet opening in order to introduce flowable matrix material into the receiving space, and a flow aid in order to distribute the matrix material in the receiving space, wherein the flow aid is configured as at least one channel at a side of at least one wall element facing the receiving space, wherein in order to produce a structural component having a desired shape, the wall elements are formable. Configured as at least one channel at a side of at least one of the wall elements facing the receiving space, the flow aid allows the production step of applying plastic fibers acting as a flow aid to be dispensed with. Production of the flow aid may easily be integrated into the production step of one of the wall elements which simplifies the entire production of the structural component semi-finished part. Furthermore, the flow aid being configured as at least one channel allows the matrix material to spread throughout the receiving space more easily since the matrix material is able to flow along the at least one channel in a substantially free manner and thus to spread throughout the receiving space rapidly and easily in order to impregnate the reinforcing fibers. This is particularly advantageous if the structural component semi-finished part has large dimensions and the flowable matrix material is introduced via a remote inlet opening.

Furthermore, the stability of a structural component made of the structural component semi-finished part is improved as compared to prior art since the space required for the non-supporting plastic fibers known from prior art is available for use as additional space for reinforcing fibers and/or matrix material. The structural component semi-finished part according to the invention also shows an improved bending behavior since the omitted plastic fibers no longer impair the bending behavior, thus allowing the bending behavior to be selectively influenced via the at least one channel. The at least one channel is preferably arranged in such a way as to improve the deformation properties of the associated wall element. Preferably, the at least one channel is formed in the first wall element.

In other words, the at least one channel allows the matrix material to easily spread throughout the entire structural component semi-finished part in order to infiltrate the reinforcing fibers. To this end, the at least one channel is preferably completely open in the direction of the receiving space. It is no longer necessary to apply the flow aid separately, which on the one hand facilitates the production of the structural component semi-finished part and allows one to save the weight and the installation space required by the flow aid known from prior art on the other. Correspondingly, the structural component semi-finished part becomes easier to produce and provides an equal or even increased amount of stability at a lower weight and a lower wall thickness. Furthermore, the at least one channel allows the introduction of the matrix material to be controlled more easily, thus resulting in an optimized matrix material flow and, correspondingly, in an optimized infiltration process for the reinforcing fibers.

Configured in such a way as to have a circumferential cross-section, the receiving space allows the matrix material to easily and rapidly spread throughout the receiving space. The structural component obtained from the structural component semi-finished part further has a high stability and load bearing capacity.

The wall elements are formable, thus providing a simple manner of forming the structural component semi-finished part in order to produce a structural component having a desired shape. The wall elements and the structural component semi-finished parts are preferably formable manually. To this end, the wall elements may for instance be made of a flexible material such as plastic material, foam material or a rubber-like material. Furthermore, at least one of the wall elements may be made of metal or may comprise a metal layer. If the metal layer is sufficiently thin, the wall element is deformable manually which provides the advantage that the wall element will remain in the desired shape on its own without the need to be fixed in the desired shape by auxiliary means in order to be infiltrated with the matrix material. For instance, the first wall element may comprise an aluminum layer referred to as aluminum inliner.

The wall elements are formable to such an extent that a structural component is producible which has an at least partly curved or bent desired shape. The inlet opening for introducing the matrix material is preferably formed at a front side of the structural component semi-finished part where the receiving space is open. Due to the fact that the wall elements are formable and the second outer wall element is not formed by a female mold, a structural component may easily be produced such as to have a desired and at least partly curved shape by deforming the wall elements and introducing the matrix material into the receiving space. The matrix material may be introduced after forming the wall elements or prior to forming the wall elements. The structural component semi-finished part preferably has a length of less than 10 m, preferably of less than 6 m, preferably of less than 4 m, preferably of less than 3 m, preferably of less than 2.5 m, and preferably of less than 2.0 m to ensure a simple and rapid production of structural components.

A structural component semi-finished part in which the at least one channel is formed at least at an outer side of the first wall element provides a simple and improved manner of introducing the matrix material. The first wall element is for instance configured as a hollow profile, a semi profile or a solid profile when seen in cross-section. The first wall element may for instance be made of metal and/or plastic material. The first wall element is deformable, in other words flexible, thus allowing the structural component semi-finished part to be deformed in such a way that a desired shape is obtained. Depending on the material, the wall element may be configured in such a way as to remain in the desired shape on its own after deformation. The first, in other words inner wall element is therefore preferably plastically deformable. Seen in cross-section, the second, in other words outer wall element is configured as a hollow profile corresponding to the first wall element which surrounds the first wall element configured as a hollow profile, semi profile or solid profile. The wall elements are in particular tubular, having a circular cross-section.

A structural component semi-finished part in which the at least one channel is formed at least at an inner side of the second wall element provides a simple and improved manner of introducing the matrix material. The wall element on the one hand serves as a sheath which allows the matrix material to be introduced in the longitudinal direction of the structural component semi-finished part by means of a differential pressure, in other words a pressure below or above atmospheric. At the same time, the wall element provides the flow aid, wherein the at least one channel allows one to selectively control the flow of the matrix material. The wall element is for instance made of metal and/or plastic material. The wall element is for instance configured as a plastic hose or tube or as a heat-shrinkable hose.

A structural component semi-finished part in which at least one channel is formed at the first wall element and at least one channel is formed at the second wall element ensures a rapid distribution of the matrix material in the receiving space. Due to the fact that both wall elements are provided with at least one channel, a high amount of a matrix material may be introduced into the receiving space in a short time, thus resulting in a short infusion time.

A structural component semi-finished part in which the at least one channel has a channel direction which forms an angle α with the longitudinal direction, wherein the angle α has an absolute value such that α≧0°, in particular α≧5°, and in particular α≧10°, ensures that the matrix material also spreads throughout the receiving space in a direction transverse to the longitudinal direction. Depending on the design of the structural component semi-finished part, the angle α applies to exactly one channel, to more than one channel, or to all channels.

A structural component semi-finished part in which the at least one channel has a channel direction which forms an angle α with the longitudinal direction, wherein the angle α has an absolute value such that α<90°, in particular α≦85°, and in particular α≦80°, ensures that the matrix material spreads throughout the receiving space in the longitudinal direction. Depending on the design of the structural component semi-finished part, the angle α applies to exactly one channel, to more than one channel, or to all channels.

A structural component semi-finished part in which the at least one channel has a channel direction which forms an angle β with a fiber direction of the closest reinforcing fibers, wherein the angle β has an absolute value such that β≦5°, in particular β≦10°, and in particular β≦15°, ensures a free flow of the matrix material in the at least one channel. Due to the fact that the channel direction forms an angle β with the fiber direction of the closest reinforcing fibers, the reinforcing fibers are not able to enter the at least one channel where they might impair the flow of the matrix material. Depending on the design of the structural component semi-finished part, the angle β applies to exactly one channel, to more than one channel, or to all channels.

A structural component semi-finished part in which at least one of the wall elements is provided with at least two channels ensures a rapid distribution of the matrix material in the receiving space. The at least two channels allow a comparatively large amount of matrix material to spread throughout the receiving space.

A structural component semi-finished part in which the at least two channels are parallel to each other ensures a unidirectional distribution of the matrix material in the receiving space. The at least two parallel channels may be arranged in the form of longitudinal channels which are parallel to the longitudinal direction. Alternatively, the at least two parallel channels may be arranged in the form of helical channels, wherein their channel directions form an angle α with the longitudinal direction that is greater than 0°.

A structural component semi-finished part in which the two channels cross each other ensures a rapid distribution of the matrix material in several directions. The channel directions of the at least two channels crossing each other form an angle γ, wherein the angle γ is preferably such that γ≧10°, in particular γ≧20°, and in particular γ≧30°. Preferably, the angle γ is such that γ<90°, in particular γ≦85°, and in particular γ≦80°. The channel directions are preferably arranged symmetrically with respect to the longitudinal direction. Two channels crossing each other allow a biaxial distribution of the matrix material to be achieved. In addition to the channels crossing each other, at least two parallel channels may be provided, thus resulting in a triaxial distribution of the matrix material. The number and arrangement of the channels in particular also allows the bending behavior of the structural component semi-finished part to be selectively influenced.

A structural component semi-finished part in which the at least one channel has a maximum depth T and a maximum width B when seen in cross-section ensures a free flow of the matrix material in the at least one channel. The ratio of maximum depth to maximum width prevents the at least one channel from being clogged by the reinforcing fibers and/or the matrix material. The ratio T/B is in particular such that T/B≧0.8, in particular T/B≧1.0, and in particular T/B≧1.2. The ratio T/B is preferably such that T/B≦2.5, in particular T/B≦2.3, and in particular T/B≦2.1.

A structural component semi-finished part in which the second wall element has an outer diameter D when seen in cross-section, and the wall elements are formable to such an extent that a radius of curvature of less than 10 D, in particular of less than 8 D, in particular of less than 6 D, and in particular of less than 4 D is achievable, allows structural components to be produced which have comparatively small radii of curvature.

A structural component semi-finished part in which all channels in the first wall element extend exclusively parallel to the longitudinal direction provides a simple manner of producing a structural component. It is easily possible to form channels in the first wall element that extend parallel to the longitudinal direction. The first wall element is preferably made of metal such as aluminum. Preferably, the first wall element is configured as an extruded profile.

A structural component semi-finished part in which all channels in the first wall element have a channel direction, and the channel direction forms an angle α with the longitudinal direction, wherein the angle α has an absolute value such that 45°≦α<90°, in particular 60°≦α≦90°, and in particular 75°≦α<90°, allows the matrix material to easily spread throughout the receiving space in the longitudinal and transverse directions. Furthermore, arranging the at least one channel in a helical configuration is a simple manner of achieving a deformability or bendability. Preferably, the first wall element has exactly one channel which is helical. Alternatively, more than one channel may be helical. Preferably, all channels are helical and parallel to each other.

A structural component semi-finished part in which the first wall element is made of a material such that it remains in the desired shape on its own after deformation, wherein the material in particular comprises a metal, remains in the desired curved or bent shape after forming, thus requiring no additional auxiliary means in order to produce the structural component. In particular, no fixing means and no female mold are required. The first wall element may either be entirely made of a flexible metal or may at least be provided with a flexible metal layer. This ensures the plastic deformability.

A structural component semi-finished part in which the first wall element is made of a plastic material, in particular a thermoplastic and/or elastomeric plastic material, is easily deformable or bendable. After the structural component semi-finished part has been formed, it is fixed in spots and/or regions using auxiliary means or fixing means to ensure that the structural component semi-finished part remains in the desired shape. The auxiliary means or fixing means do not constitute a female mold since the receiving space is bounded by the second, in other words outer wall element even if it is partly fixed.

A structural component semi-finished part in which the at least one channel tapers in the direction of the receiving space improves the introduction of the matrix material. Since the at least one channel tapers in the direction of the receiving space, the matrix material is accelerated in the direction of the receiving space and the reinforcing fibers. The at least one channel is preferably formed in the first wall element, with the result that the at least one channel tapers in the direction of the receiving space starting from the central longitudinal axis.

A structural component semi-finished part in which the second wall element has an outer diameter D and a radial wall thickness W, wherein 5≦D/W≦30, and in particular 10≦D/W≦20, ensures the deformability of the second wall element on the one hand and the stability thereof on the other which is required in order to introduce the matrix material.

A structural component semi-finished part in which the second wall element has a hardness of no more than 100 Shore A, in particular of no more than 90 Shore A, and in particular of no more than 80 Shore A ensures a sufficient stability of the second wall element in order to introduce the matrix material.

A structural component semi-finished part in which the second wall element has an outer diameter D, wherein 10 mm≦D≦200 mm, in particular 15 mm≦D≦150 mm, and in particular 20 mm≦D≦100 mm, provides a simple manner of producing structural components for a myriad of applications.

A structural component semi-finished part in which the second wall element is configured as a hollow profile, wherein the cross-section is in particular circular, oval or rectangular, provides a simple manner of producing tubular structural components having different cross-sectional shapes.

A structural component semi-finished part in which the at least one wall element is configured in one piece allows structural components to be produced more easily in such a way that the properties thereof meet the actual requirements. Preferably, both wall elements are configured in one piece. The one-piece design allows the first wall element and/or the second wall element to be easily removed after the matrix material has cured. This results in a low weight of the structural component. Furthermore, the structural component has a smooth surface after removing the second wall element if said second wall element is not provided with channels. This allows visually appealing structural components to be produced which do not require any further treatment.

A structural component semi-finished part in which the second wall element is made of a plastic material, in particular of a thermoplastic and/or elastomeric plastic material, is easily deformable or bendable. The outer wall element is for instance made of PVC.

Another object of the invention is to provide a fiber-reinforced structural component having a desired shape which is easy to produce.

This object is achieved by a fiber-reinforced structural component comprising a first wall element, a second wall element surrounding the first wall element, a receiving space which is bounded by the wall elements at least in a transverse direction, which extends between the wall elements in a longitudinal direction, and which has a circumferential cross-section, reinforcing fibers arranged in the receiving space, an inlet opening in order to introduce flowable matrix material into the receiving space, and a flow aid in order to distribute the matrix material in the receiving space, wherein the flow aid is configured as at least one channel at a side of at least one wall element facing the receiving space, wherein in order to produce a structural component having a desired shape, the wall elements are formable, wherein the receiving space and the at least one channel are filled with a matrix material such that the reinforcing fibers are provided with the matrix material, and wherein the matrix material has cured in the desired shape. Configured as at least one channel, the flow aid allows the structural component semi-finished part according to the invention to be easily deformed into a desired curved or bent shape in order to be provided with matrix material along a comparatively large length. The at least one channel allows the matrix material to spread throughout the receiving space rapidly and easily in order to impregnate the reinforcing fibers without impairing the desired shape. When the matrix material has cured, the fiber-reinforced structural component is obtained which has a high stiffness and load-bearing capacity. The easy formation of the structural component semi-finished part and the easy introduction of the matrix material even allow fiber-reinforced structural components to be produced which have a comparatively large length. In other words, the fiber-reinforced structural component has a desired shape which is at least partly curved.

Another object of the invention is to provide a simple method for producing a fiber-reinforced structural component having a desired shape.

This object is achieved by a method for the production of a fiber-reinforced structural component, the method comprising the steps of providing a structural component semi-finished part according to the invention, forming the structural component semi-finished part in order to produce a desired shape, introducing flowable matrix material into the receiving space via the inlet opening, wherein the matrix material flows along the at least one channel so as to spread throughout the receiving space, and the reinforcing fibers are provided with the matrix material, curing the matrix material such that the structural component semi-finished part arranged in the desired shape permanently remains in the desired shape so as to form the structural component. The structural component semi-finished part allows a desired curved or bent shape to be produced easily while ensuring that the matrix material is easily introducible into the receiving space via the inlet opening, with the result that the matrix material spreads throughout the receiving space rapidly in order to provide the reinforcing fibers with the matrix material. The desired shape may be produced prior to or after introducing the flowable matrix material. Preferably, the flowable material is introduced into the receiving space by means of a differential pressure, in other words a pressure above or below atmospheric. Curing of the matrix material may generally take place in any desired way, for instance at room temperature or under the influence of heat in order to accelerate the curing process. The method according to the invention in particular allows fiber-reinforced structural components to be produced rapidly in such a way as to have a comparatively large length. The fiber-reinforced structural component is therefore easily producible in such a way as to have an at least partly curved desired shape.

A method in which the structural component semi-finished part remains in the desired shape on its own after deforming allows the fiber-reinforced structural component to be produced easily. Since the structural component semi-finished part remains in the desired shape due to its plastic deformability, no additional auxiliary means or fixing means are required. In particular, no female mold is required.

A method in which the structural component semi-finished part is fixed in the desired shape in spots and/or regions provides a simple manner for the structural component semi-finished part to remain in the desired shape. The auxiliary means or fixing means ensure that the structural component semi-finished part is fixed in spots and/or regions. A female mold is not required. Fixing the structural component semi-finished part in particular regions does not constitute a female mold since the receiving space is bounded by the second wall element.

A method in which at least one of the wall elements is removed after the matrix material has cured allows structural components to be produced such as to have desired properties. By removing the first wall element and/or the second wall element, the structural component has a low weight. If the second wall element is not provided with channels, a smooth surface of the structural component is obtained when the second wall element is removed.

The present invention will be explained in more detail below on the basis of drawings, which show exemplary embodiments only. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a fiber-reinforced structural component according to a first exemplary embodiment;

FIG. 2 is an axial sectional view through the structural component in FIG. 1;

FIG. 3 is a cross-sectional view through the structural component in FIG. 1;

FIG. 4 is a side view of a first inner wall element of the structural component in FIG. 1;

FIG. 5 is a cross-sectional view through a fiber-reinforced structural component according to a second exemplary embodiment;

FIG. 6 is a cross-sectional view through a fiber-reinforced structural component according to a third embodiment;

FIG. 7 is a side view of a first wall element for a fiber-reinforced structural component according to a fourth embodiment;

FIG. 8 is a side view of a first wall element for a fiber-reinforced structural component according to a fifth embodiment;

FIG. 9 is a side view of a first wall element for a fiber-reinforced structural component according to a sixth embodiment;

FIG. 10 is a side view of a first wall element for a fiber-reinforced structural component according to a seventh embodiment;

FIG. 11 is a cross-sectional view through a first wall element of a fiber-reinforced structural component according to an eighth embodiment;

FIG. 12 is a cross-sectional view through a first wall element of a fiber-reinforced structural component according to a ninth embodiment;

FIG. 13 is a cross-sectional view through a first wall element of a fiber-reinforced structural component according to a tenth embodiment;

FIG. 14 is a cross-sectional view through a first wall element of a fiber-reinforced structural component according to an eleventh embodiment;

FIG. 15 is a cross-sectional view through a first wall element of a fiber-reinforced structural component according to a twelfth embodiment;

FIG. 16 is a cross-sectional view through a first wall element of a fiber-reinforced structural component according to a thirteenth embodiment;

FIG. 17 is a cross-sectional view through a first wall element of a fiber-reinforced structural component according to a fourteenth embodiment;

FIG. 18 is a cross-sectional view through a first wall element of a fiber-reinforced structural component according to a fifteenth embodiment; and

FIG. 19 is a partial cross-sectional view through a first wall element of a fiber-reinforced structural component according to a sixteenth embodiment.

### DESCRIPTION OF THE PREFERRED EMBODIMENTS

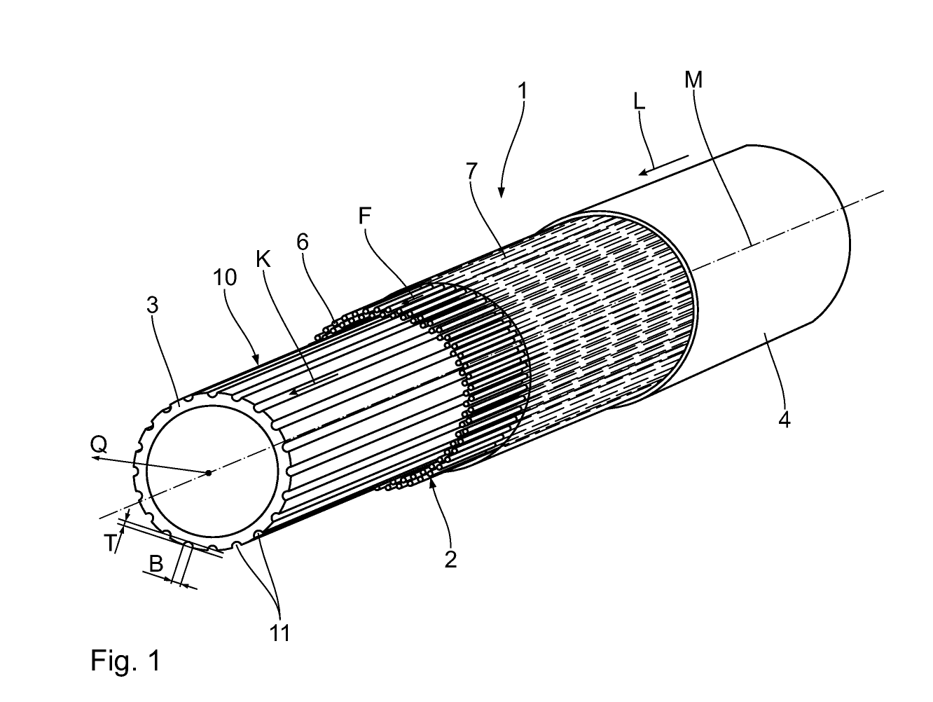

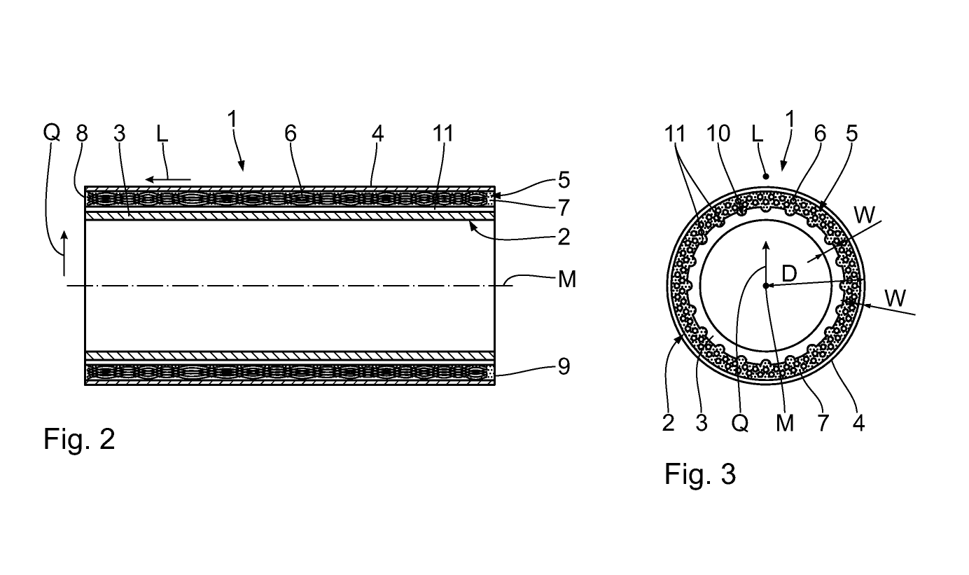

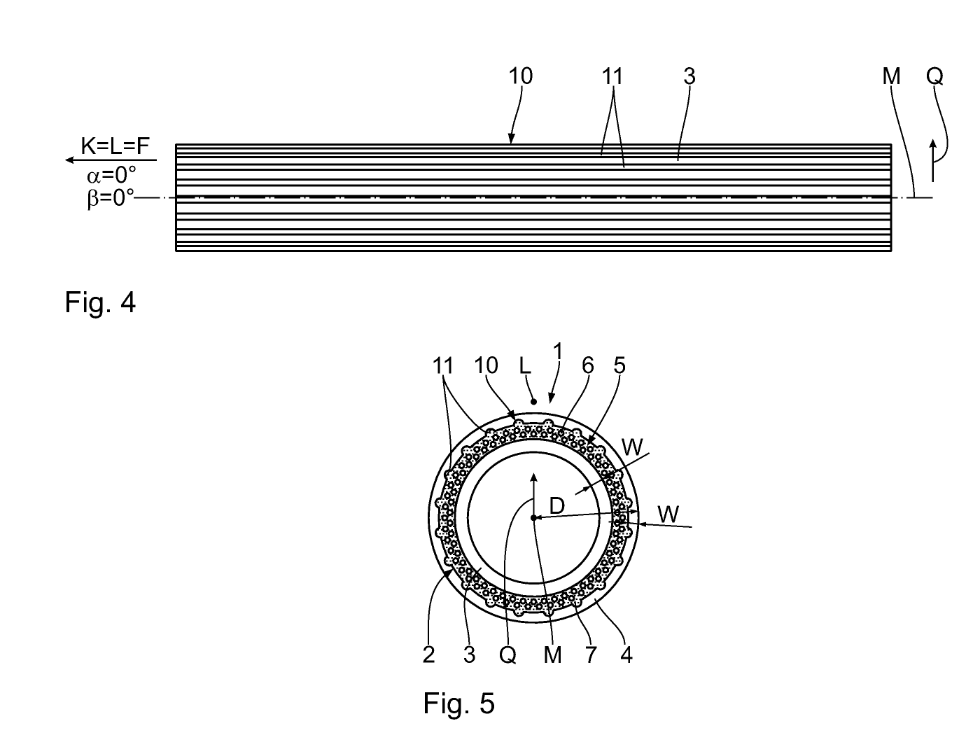

The following is a description of a first exemplary embodiment of the invention with reference to FIGS. 1 to 4. A fiber-reinforced structural component 1 is made from a structural component semi-finished part 2. The structural component semi-finished part 2 comprises a first inner wall element 3 which is surrounded by a second outer wall element 4. The wall elements 3, 4 are arranged concentrically to a central longitudinal axis M of the structural component semi-finished part 2. The wall elements 3, 4 are configured as hollow cylinders and have in particular a circular cross-section. In a radial direction referred to as transverse direction Q, the wall elements 3, 4 define a receiving space 5 between each other which extends in a longitudinal direction L. A plurality of reinforcing fibers 6 are arranged in the receiving space 5. The reinforcing fibers 6 may be applied in one or more than one layers and may be woven braided or wound. Suitable reinforcing fibers 6 are for instance carbon fibers, glass fibers, aramid fibers, basalt fibers, hemp fibers and/or bamboo fibers.

In order to introduce flowable matrix material 7, the front sides of the structural component semi-finished part 2 are in each case provided with an inlet opening 8, 9 which lead into the receiving space 5. In order to distribute the matrix material 7 throughout the receiving space 5, the structural component semi-finished part 2 is provided with a flow aid 10 which is configured in the form of channels 11. The channels 11 are formed at a side of the first wall element 3 facing the receiving space 5.

The wall elements 3, 4, the receiving space 5 comprising the inlet openings 8, 9, the reinforcing fibers 6 and the flow aid 10 constitute the structural component semi-finished part 2.

The channels 11 are parallel to each other and parallel to the longitudinal direction L. A channel direction K forms an angle α with the longitudinal direction L, wherein the angle α is such that α=0°. The reinforcing fibers 6 closest to the channels 11 have a fiber direction F which is parallel to the longitudinal direction L. An angle β between the channel direction K and the fiber direction F is such that β=0°.

Due to the fact that the wall elements 3, 4 are configured as hollow cylinders, the receiving space 5 has a circumferential cross-section in the form of an annular space. The channels 11 are formed at in the wall element 3 at equal angular distances about the central longitudinal axis M. Each of the channels 11 has a maximum depth T and a maximum width B, wherein T/B≧0.8, in particular T/B≧1.0, and in particular T/B≧1.2.

The wall elements 3, 4 are made of a material such that the structural component semi-finished part 2 is manually deformable into a desired shape. To this end, the wall elements 3, 4 are for instance made of plastic material, wherein the wall element 3 may for instance comprise an aluminum layer, in other words an aluminum inliner.

In order to produce the fiber-reinforced structural component 1, the structural component semi-finished part 2 is initially deformed into a desired shape. Subsequently, flowable matrix material 7 is introduced via one of the inlet openings 8, 9. This is preferably carried out in such a way that a differential pressure, in other words a pressure below or above atmospheric, is applied between the inlet openings 8, 9. The matrix material 7 flows through the channels 11 and into the receiving space 5 where it moistens, in other words impregnates the reinforcing fibers 6. The channels 11 are completely open in the direction of the receiving space 5, thus allowing the matrix material 7 to flow into the receiving space 5 along the channels 11 and in the transverse direction Q. As a result, the receiving space 5 is easily and rapidly filled with the matrix material 7, causing the reinforcing fibers 6 to be impregnated with the matrix material 7. Subsequently, the matrix material 7 cures in the desired shape of the structural component semi-finished part 2 so that the structural component 1 is obtained. Curing may occur at room temperature or under the influence of heat. If necessary, the wall elements 3, 4 may subsequently be removed.

The following is a description of a second exemplary embodiment of the invention with reference to FIG. 5. In contrast to the first exemplary embodiment, the channels 11 are formed at an inner side of the second wall element 4. Further details concerning the design and functioning can be found in the description of the first exemplary embodiment.

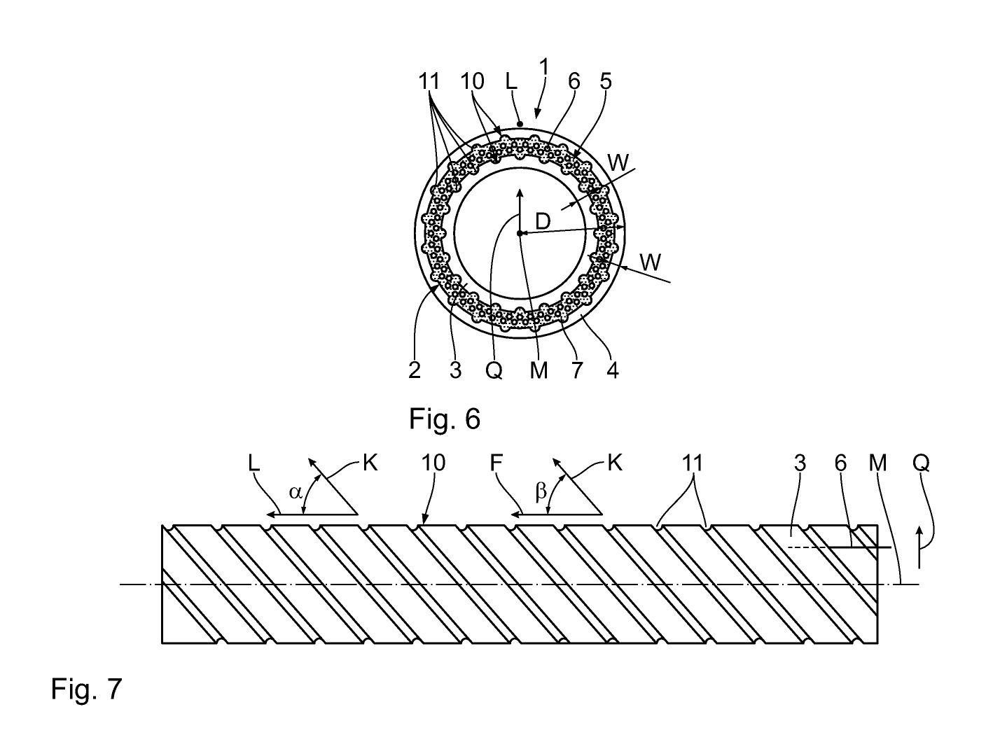

The following is a description of a third exemplary embodiment of the invention with reference to FIG. 6. In this embodiment, channels 11 are formed at the sides of both wall elements 3, 4 facing the receiving space 5. Further details concerning the design and functioning can be found in the description of the preceding exemplary embodiments.

The following is a description of a fourth exemplary embodiment of the invention with reference to FIG. 7. The flow aid 10 is configured as a helical channel 11 at the first wall element 3. As an alternative or in addition thereto, a corresponding channel 11 may be formed at the second wall element 4. The channel direction K forms an angle of α≈45° with the longitudinal direction L. The fiber direction F of the closest reinforcing fibers 6 is parallel to the longitudinal direction L and forms an angle β≈45° with the channel direction K. Further details concerning the design and functioning can be found in the description of the preceding exemplary embodiments.

The following is a description of a fifth exemplary embodiment of the invention with reference to FIG. 8. In contrast to the fourth embodiment, the channel direction K forms an angle α≈80° with the longitudinal direction L. The fiber direction F of the reinforcing fibers 6 runs at an angle of approx. 30° relative to the longitudinal direction L, causing the fiber direction F and the channel direction K to form an angle β≈70°. Further details concerning the design and functioning can be found in the description of the preceding exemplary embodiments.

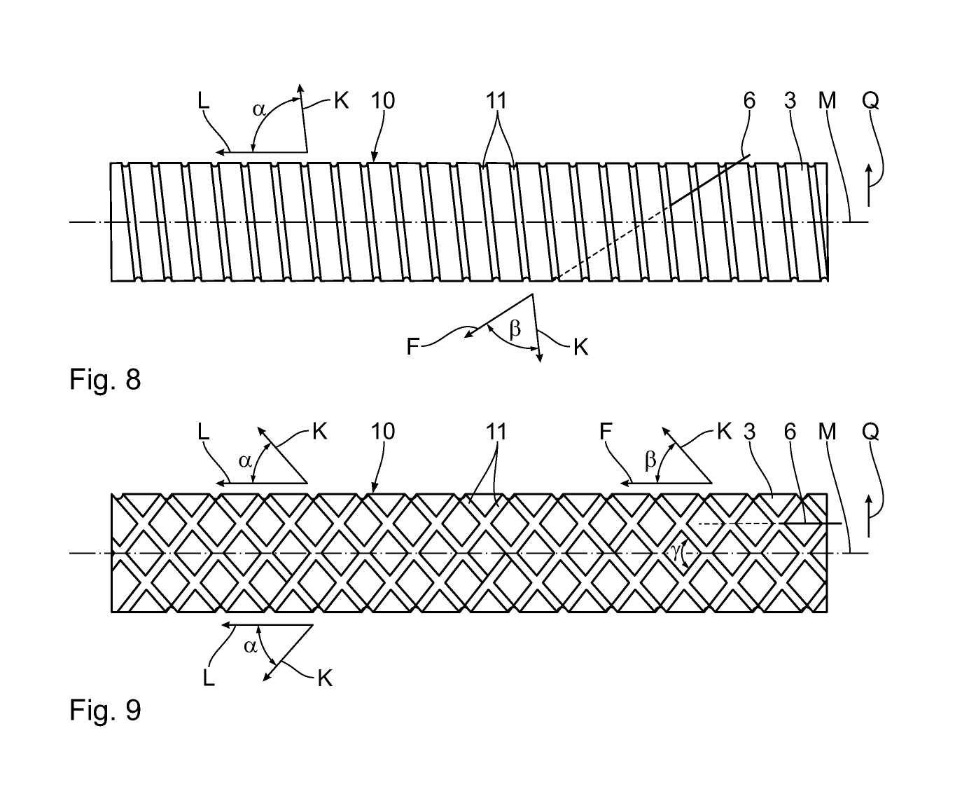

The following is a description of a sixth exemplary embodiment of the invention with reference to FIG. 9. At the side of the wall element 3 facing the receiving space 5, two helical channels 11 are formed which cross each other and run at an angle of substantially γ≈90° relative to each other and at an angle of in each case α≈45° relative to the longitudinal direction L. The fiber direction F of the reinforcing fibers 6 is parallel to the longitudinal direction L so that the angle β amounts to ≈70°. Further details concerning the design and functioning can be found in the description of the preceding exemplary embodiments.

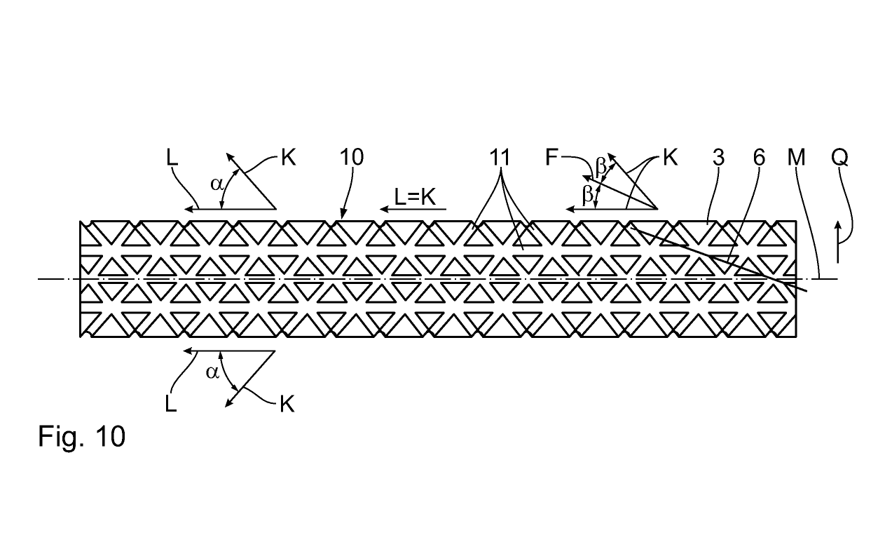

The following is a description of a seventh exemplary embodiment of the invention with reference to FIG. 10. Corresponding to the first and sixth exemplary embodiments, the seventh exemplary embodiment has a number of channels 11 running parallel to the longitudinal direction L and two helical channels 11 which each extend at an angle of α≈45° relative to the longitudinal direction L. The channels 11 are formed at the first wall element 3. As an alternative or in addition thereto, the channels 11 may be formed at the second wall element 4. The fiber direction F extends at an angle of β≈22.5° relative to the channel directions K. Further details concerning the design and functioning can be found in the description of the preceding exemplary embodiments.

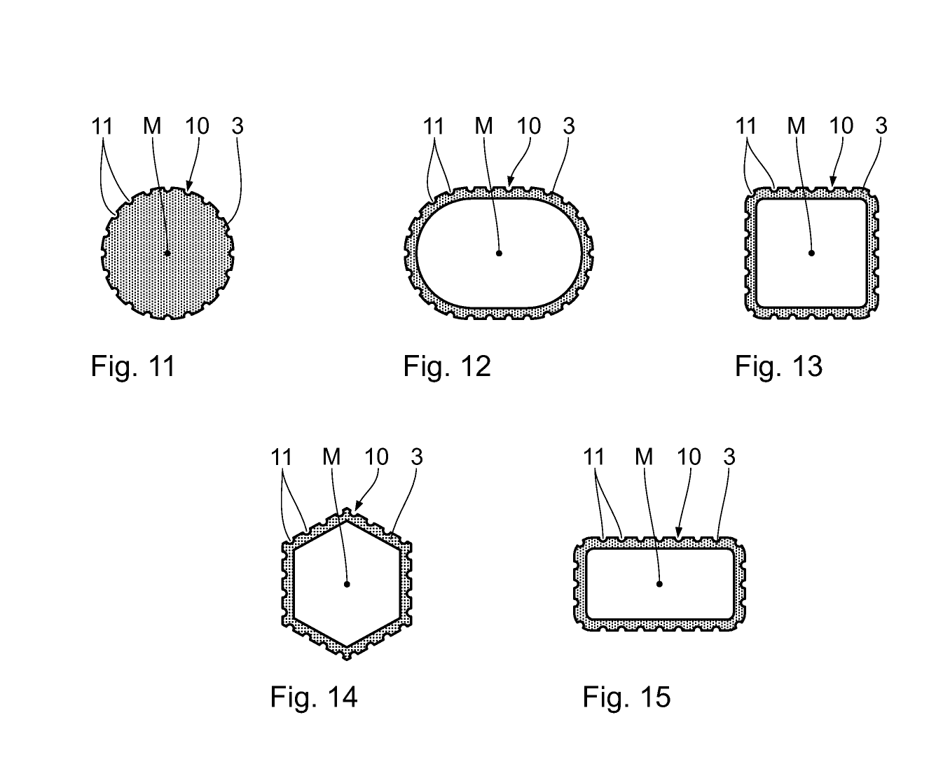

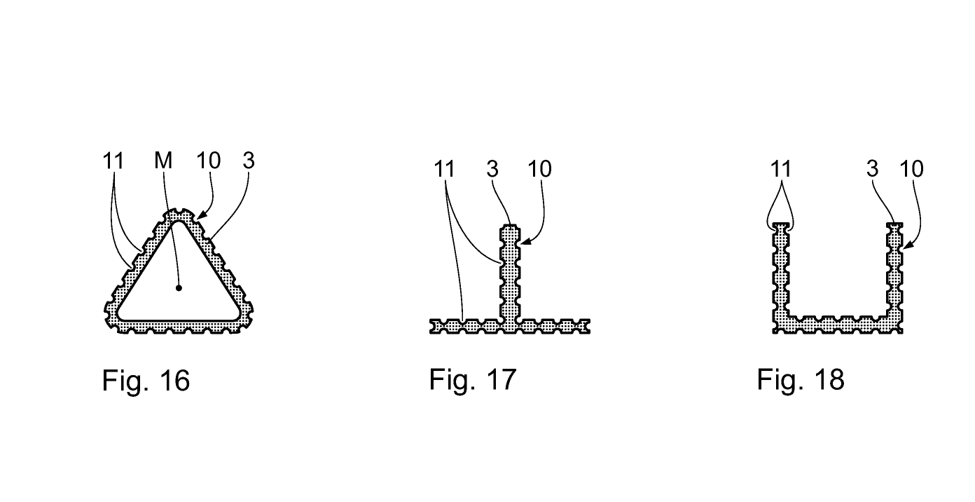

The following is a description of several exemplary embodiments of the invention with reference to FIGS. 11 to 18. In the exemplary embodiment according to FIG. 11, the first wall element 3 is configured as a solid profile. The exemplary embodiments according to FIGS. 12 to 16 each show a hollow cylindrical design of the wall element 3 having an oval cross-section, a square cross-section, a polygonal cross-section, a rectangular cross-section and a triangular cross-section. The channels 11 may be formed at the wall element 3 and/or at the wall element 4. The exemplary embodiments according to FIGS. 17 and 18 have a T-shaped cross-section and a U-shaped cross-section, respectively. Further details concerning the design and functioning can be found in the description of the preceding exemplary embodiments.

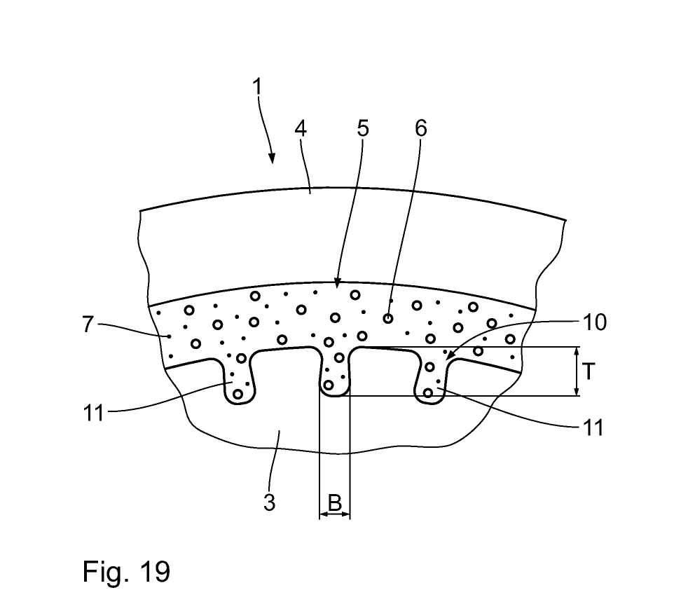

The following is a description of a sixteenth exemplary embodiment of the invention with reference to FIG. 19. In contrast to the preceding exemplary embodiments, the sixteenth exemplary embodiment has channels 11 which taper in the direction of the receiving space 5. The channels 11 are formed in the first wall element 3 and/or the second wall element 4. The channels 11 have a maximum depth T which is greater than a maximum width B. Further details concerning the design and functioning can be found in the description of the preceding exemplary embodiments.

The structural component semi-finished part 2 according to the invention allows freely formed fiber-reinforced structural components 1 to be produced which can be produced by infiltration of a matrix material 7, in other words a resin, without requiring a female mold or a tool. The structural component semi-finished part is preferably flexible, allowing it to be deformed into a desired shape prior to the curing process. This may either be done in a dry state, in other words prior to the introduction of the matrix material 7, or in an already infused state as long as the matrix material 7 is still liquid. Furthermore, a matrix material 7 may be used that softens or liquefies again under the influence of heat, allowing the material to be remolded. The cured structural component 1 may be a hybrid component composed of the wall elements 3, 4 and a fiber composite layer. The fiber composite layer consists of the reinforcing fibers 6 and the cured matrix material 7. Alternatively, one of the wall elements 3, 4 or both wall elements 3, 4 may be removed from the fiber composite layer so that the fiber-reinforced structural component 1 consists exclusively of by the fiber composite layer.

As a general rule, the first wall element 3 may have the most various cross-sectional shapes. The reinforcing fibers 6 may be applied in one or more than one layers. The reinforcing fibers 6, in other words the layers, may be woven, braided or wound. When the structural component semi-finished part 2 is deformed into a desired shape, the fiber layer is preferably drapable or expandable and is thus easily formable. The fiber layers may be applied manually or by means of a machine.

The matrix material 7 may be a thermosetting or a thermoplastic resin system which has a sufficiently low viscosity for the infiltration and/or bending process. The matrix material 7 may be introduced by means of a differential pressure prior to or after the bending process of the structural component semi-finished part 2. Curing of the matrix material 7, in other words the resin, may either take place at room temperature or under the influence of heat in order to accelerate the curing process.

The second wall element 4 allows the matrix material 7 to be introduced without a female tool since a pressure below or above atmospheric may be build up between the wall elements 3, 4 along the longitudinal direction L, allowing the matrix material 7 to be transported into the reinforcing fibers 6 via the flow aid 10. The second wall element 4 may for instance be made of plastics and may be applied manually or by means of a machine. Examples of manually applied wall elements 4 are plastic hoses or tubes or heat-shrinkable hoses. Examples of wall elements 4 applied by means of a machine are extruded thermoplastics or plastic as well as heat-shrinkable bands that are wound on by means of a machine.

The wall elements 3, 4 are preferably configured in such a way that a radius of curvature of the structural component semi-finished part 2 is achievable, wherein the radius of curvature is in particular smaller than ten times, in particular eight times, in particular six times, and in particular four times the outer diameter D of the second wall element 4. The outer diameter D and the wall thickness W of the second wall element 4 are in particular selected such that the second wall element 4 has an outer diameter D and a radial wall thickness W, wherein 5≦D/W≦30 and in particular 10≦D/W≦20. The outer wall element 4 is preferably made of material that has a hardness of no more than 100 Shore A, in particular of no more than 90 Shore A, and in particular of no more than 80 Shore A. The outer diameter D of the second wall element 4 preferably amounts to 10 mm≦D≦200 mm, in particular 15 mm≦D≦150 mm, and in particular 20 mm≦D≦100 mm. The first wall element 3 and/or the second wall element 4 is preferably configured in one piece. The first wall element 3 and/or the second wall element 4 may be removed after the matrix material 7 has cured so that the structural component 1 has a low weight. If the second wall element 4 is not provided with channels, the structural component 1 has a smooth surface after removing the outer wall element 4.

The wall thickness W of the first wall element 3 and/or the second wall element 4 is between 1 mm and 6 mm, in particular between 1.5 mm and 5 mm, and in particular between 2 mm and 4 mm. The wall thickness W of the wall elements 3, 4 may be identical or different. The wall thickness W in particular depends on whether the respective wall element 3, 4 is provided with at least one channel 11.

If the structural component semi-finished part 2 is plastically deformable, it remains in its at least partly curved desired shape on its own after forming or bending so that no auxiliary means or fixing means are required. If, however, the structural component semi-finished part 2 is made of an elastically deformable or flexible material, the curved desired shape can be maintained in the at least partly curved desired shape by fixing it in spots or regions. This may be done using simple auxiliary means or fixing means. In any case, a female mold is not required.

Depending on the desired properties of the structural component 1, the features of the individual exemplary embodiments may be combined as required to obtain a structural component semi-finished part 2 or a fiber-reinforced structural component 1.

While specific embodiments of the invention have been shown and described in detail to illustrate the application of the principles of the invention, it will be understood that the invention may be embodied otherwise without departing from such principles.

1. A structural component semi-finished part for the production of a fiber-reinforced structural component, comprising:
a first wall element;
a second wall element surrounding the first wall element;
a receiving space, which is bounded by the first wall element and the second wall element at least in a transverse direction, said receiving space extending between the first wall element and the second wall element in a longitudinal direction, said receiving space having a circumferential cross-section;
reinforcing fibers arranged in the receiving space;
an inlet opening in order to introduce flowable matrix material into the receiving space; and
a flow aid in order to distribute the flowable matrix material in the receiving space, wherein the flow aid is configured as at least one channel at a side of at least one of the first wall element and the second wall element facing the receiving space, wherein in order to produce a structural component having a desired shape, the first wall element and the second wall element are formable.

2. A structural component semi-finished part according to claim 1, wherein the at least one channel is formed at least at an outer side of the first wall element.

3. A structural component semi-finished part according to claim 1, wherein the at least one channel is formed at least at an inner side of the second wall element.

4. A structural component semi-finished part according claim 1, wherein at least one channel is formed at the first wall element and at least one channel is formed at the second wall element.

5. A structural component semi-finished part according to claim 1, wherein the at least one channel has a channel direction which forms an angle α with the longitudinal direction, wherein the angle α has an absolute value such that α≧0°.

6. A structural component semi-finished part according to claim 1, wherein the at least one channel has a channel direction which forms an angle α with the longitudinal direction, wherein the angle α has an absolute value such that α<90°.

7. A structural component semi-finished part according to claim 1, wherein the at least one channel has a channel direction which forms an angle β with a fiber direction of the closest reinforcing fibers, wherein the angle β has an absolute value such that β≧5°.

8. A structural component semi-finished part according to claim 1, wherein at least one of the first wall element and the second wall element is provided with at least two channels.

9. A structural component semi-finished part according to claim 8, wherein the at least two channels are parallel to each other.

10. A structural component semi-finished part according to claim 8, wherein the at least two channels cross each other.

11. A structural component semi-finished part according to claim 1, wherein seen in cross-section, the at least one channel has a maximum depth T and a maximum width B, wherein T/B≧0.8.

12. A structural component semi-finished part according to claim 1, wherein seen in cross-section, the second wall element has an outer diameter D, and the first wall element and the second wall element are formable to such an extent that a radius of curvature of less than 10 D is achievable.

13. A structural component semi-finished part according to claim 1, wherein all channels in the first wall element extend exclusively parallel to the longitudinal direction.

14. A structural component semi-finished part according to claim 1, wherein all channels in the first wall element have a channel direction, and the channel direction forms an angle α with the longitudinal direction, wherein the angle α has an absolute value such that 45°≦α<90°.

15. A structural component semi-finished part according to claim 1, wherein the first wall element is made of a material such that the first wall element remains in the desired shape after deformation of the first wall element.

16. A structural component semi-finished part according to claim 1, wherein the first wall element is made of a plastic material.

17. A structural component semi-finished part according to claim 1, wherein the at least one channel tapers in the direction of the receiving space.

18. A structural component semi-finished part according to claim 1, wherein the second wall element has an outer diameter D and a radial wall thickness W, wherein 5≦D/W≦30.

19. A structural component semi-finished part according to claim 1, wherein the second wall element has a hardness of no more than 100 Shore A.

20. A structural component semi-finished part according to claim 1, wherein the second wall element has an outer diameter D, wherein 10 mm≧D≧200 mm.

21. A structural component semi-finished part according to claim 1, wherein the second wall element is configured as a hollow profile.

22. A structural component semi-finished part according to claim 1, wherein the at least one of the first wall element and the second wall element is configured in one piece.

23. A structural component semi-finished part according to claim 1, wherein the second wall element is made of a plastic material.

24. A fiber-reinforced structural component comprising:
a first wall element,
a second wall element surrounding the first wall element;
a receiving space bounded by the first wall element and the second wall element at least in a transverse direction, said receiving space extending between the first wall element and the second wall element in a longitudinal direction, said receiving space having a circumferential cross-section;
reinforcing fibers arranged in the receiving space;
an inlet opening in order to introduce flowable matrix material into the receiving space; and
a flow aid in order to distribute the flowable matrix material in the receiving space, wherein the flow aid is configured as at least one channel at a side of at least one of the first wall element and the second wall element facing the receiving space, wherein in order to produce a structural component having a desired shape, the wall elements are formable, the receiving space and the at least one channel being filled with the flowable matrix material such that the reinforcing fibers are provided with the flowable matrix material, the flowable matrix material being cured in the desired shape.

25. A method for production of a fiber-reinforced structural component, the method comprising the following steps:
providing a structural component semi-finished part, said structural semi-finished part comprising a first wall element, a second wall element surrounding the first wall element, a receiving space, reinforcing fibers arranged in the receiving space, an inlet opening in order to introduce flowable matrix material into the receiving space and a flow aid in order to distribute the flowable matrix material in the receiving space, wherein the flow aid is configured as at least one channel at a side of at least one of the first wall element and the second wall element facing the receiving space, said receiving space being bounded by the first wall and the second wall element at least in a transverse direction, said receiving space extending between the first wall element and the second wall element in a longitudinal direction, said receiving space having a circumferential cross-section;
forming the structural component semi-finished part in order to produce a desired shape;
introducing the flowable matrix material into the receiving space via the inlet opening, wherein the flowable matrix material flows along the at least one channel so as to spread throughout the receiving space, and the reinforcing fibers are provided with the flowable matrix material;
curing the flowable matrix material such that the structural component semi-finished part arranged in the desired shape permanently remains in the desired shape so as to form the structural component.

26. A method according to claim 25, wherein after deforming, the structural component semi-finished part remains in the desired shape.

27. A method according to claim 25, wherein the structural component semi-finished part is fixed in the desired shape in at least one of spots and regions.

28. A method according to claim 25, wherein at least one of the first wall element and the second wall element is removed after the flowable matrix material has cured.
